(19) United States
(12) Patent Application Publication
(10) Pub. No.: US 2009/0197612 A1
(43) Pub. Date: Aug. 6, 2009

(54) Mobile telephone location application

(76) Inventor: Arto Kiiskinen, Espoo (FI)

Correspondence Address: HARRINGTON & SMITH, PC, 4 RESEARCH DRIVE, Suite 202, SHELTON, CT, 06484-6212, US

(21) Appl. No.: 11/663,371

(22) PCT Filed: Oct. 29, 2004
(86) PCT No.: PCT/US04/35957

§ 371 Date: Mar. 19, 2007

(51) Int. Cl. H04W 24/00; H04M 1/00

(52) U.S. Cl. 455/456.1; 455/550.1

(57) ABSTRACT

A hand-held mobile communications device including a location determination system for determining a location of the hand-held mobile communications device; and a system for sending location information of the hand-held mobile communications device, determined by the location determination system, to a second hand-held mobile communications device. The communications devices can be mobile telephones. The location determination system can include a GPS receiver. The communications device can comprise a system for displaying the location of the second communications device and/or perform a task of a non-location specific application, such as a music player.

### BACKGROUND OF THE INVENTION

1. Field of the Invention

The present invention relates to a mobile communication device and, more particularly, to an application control system adapted to control, at least partially, an application of the mobile communication device based upon location.

2. Brief Description of Prior Developments

U.S. Pat. No. 6,198,873 discloses interactive exchanging location information in a form of a short text message between mobile units. U.S. Pat. No. 6,198,783 discloses a geographic relationship method which includes two mobile units for determining their respective locations. CDMA mobile telephones have global positioning system (GPS) receivers. Some CDMA phones exist that utilize the GPS receiver to enable location based services (LBS). In addition to location based services (LBS), mobile phones can have the usual mobile phone functions such as telephone and contacts applications and, in some cases, music, camera or video player, and/or FM radio. People also use their mobile phones actively to store their friends phone numbers, contact details, and their personal content, such as photos, music files and digital content they have purchased.

Existing dedicated GPS receivers do not usually offer the similar telephony and digital content consumption capabilities as mobile phones do. As enabling platform for digital content-focused location based services, mobile phones with GPS receivers are much better than dedicated GPS receivers. Dedicated GPS receivers only exist to show the location of the receiver itself.

It is desired that a network of location determinable enabled mobile phones could, in addition to showing the location of a user's individual mobile phone, communicate over the telecommunications network to share the location of the user's individual mobile phone to others (peer location sharing); and perhaps visa versa. This sharing could enable applications to display the location of other people (peers). There is a desire that the sharing information can be used to direct or control the digital content consumption in the terminal. For example, there is a desire to use non-location based applications, such as a music player, to be controlled based upon peer location sharing, to perform predetermined tasks. For example, the task could comprise signaling the user (or a peer of the user) by music played by a music player of the mobile phone, or such as recording or sending images (pictures or video) to a peer. There is a desire to automatically trigger this type of control based upon peer location sharing.

Location aware music players do not exist. However, some concepts exist that do convey a “state” of a device to a user. For example, a Volvo concept car has a pulsing key that pulses when all is well and alerts user by vibrating when the car has a problem.

### SUMMARY OF THE INVENTION

In accordance with one aspect of the present invention, a hand-held mobile communications device is provided comprising a location determination system for determining a location of the hand-held mobile communications device; a system for sending location information of the hand-held mobile communications device to a second hand-held mobile communications device and for receiving location information of the second hand-held mobile communications device; and a location application interface system. The location application interface system comprises a memory adapted to store at least one location rule. The location application interface system is adapted to automatically perform at least one predetermined task based, at least partially, upon a location of the hand-held mobile communications device and at least one location rule stored in the memory.

In accordance with another aspect of the present invention, a hand-held mobile communications device is provided comprising a location determination and sharing system for determining location of the hand-held mobile communications device and sharing location information with at least one second communications device; and a location application interface. The location application interface is adapted to perform at least one predetermined task based upon the location information shared with the second hand-held mobile communications device. The predetermined task comprises at least partially controlling a non-location based application of the hand-held mobile communications device.

In accordance with another aspect of the present invention, a mobile telephone location signaling system is provided comprising a first mobile telephone and a second mobile telephone. The first mobile telephone comprises a location determination and sharing system for determining a location of the first mobile telephone and transmitting information regarding the determined location. The second mobile telephone comprises a system for receiving the determined location information from the first mobile telephone. The second mobile telephone comprises a location application interface system adapted to perform at least one predetermined task of a non-location based application based upon the location information shared by the first mobile telephone. The non-location based application comprises a music player of the second mobile telephone.

In accordance with another aspect of the present invention, a hand-held mobile telephone is provided comprising a location determination system for determining a location of the hand-held mobile communications device; a location rules system for comparing location information of the hand-held mobile communications device, determined by the location determination system, to at least one user programmed location rule; and a system for sending a sensory signal to a user of the hand-held mobile telephone when the location information violates the at least one user programmed location rule.

In accordance with one method of the present invention, a method of communicating between hand-held mobile telephones is provided comprising determining a location of a first one of the hand-held mobile telephones; transmitting location information of the determined location from the first hand-held mobile telephone to a second one of the hand-held mobile telephones; and comparing the location information to a location rule in the second hand-held mobile telephone.

### BRIEF DESCRIPTION OF THE DRAWINGS

The foregoing aspects and other features of the present invention are explained in the following description, taken in connection with the accompanying drawings, wherein:

FIG. 1 is a diagram of a mobile device communication system incorporating features of the present invention;

FIG. 2 is a block diagram showing components of the mobile telephone shown in FIG. 1;

FIG. 3 is a block diagram of components of the location application interface system shown in FIG. 2; and

FIG. 4 is a diagram of one embodiment of interaction between a location application interface system with reacting applications and third-party applications.

### DETAILED DESCRIPTION OF THE PREFERRED EMBODIMENT

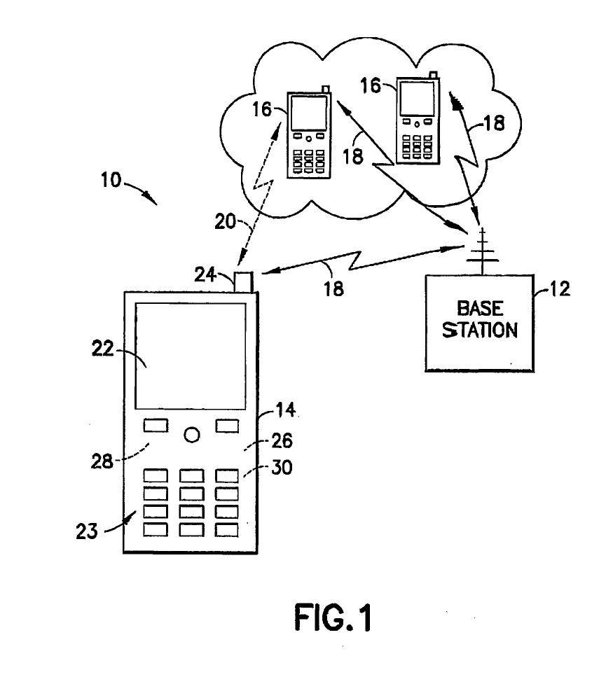

Referring to FIG. 1, there is shown a diagram of a mobile device communications system 10 incorporating features of the present invention. Although the present invention will be described with reference to the exemplary embodiment shown in the drawings, it should be understood that the present invention can be embodied in many alternate forms of embodiments. In addition, any suitable size, shape or type of elements or materials could be used.

The communications system 10 comprises a mobile telephone communications system. However, in alternate embodiments, any suitable type of wireless communications system incorporating features of the present invention could be prodded. The communications system 10 generally comprises a base station 12, a hand-held mobile telephone or communication device 14, and a plurality of other hand-held mobile telephones or communication devices 16. The communication devices 14, 16 could comprise any suitable type of wireless communications device including, for example, a laptop computer having a wireless modem, or an Internet enabled wireless game. The mobile telephone 14 can communicate with the other telephones 16 via wireless links 18 through the base station 12. The mobile telephone 14 could also communicate with other telephones by means of a satellite (not shown) connection or by means of a land line communication between the base station 12 and another base station (not shown). The mobile telephone 14 could also communicate directly with one or more of the mobile telephones 16 by a direct wireless link 20.

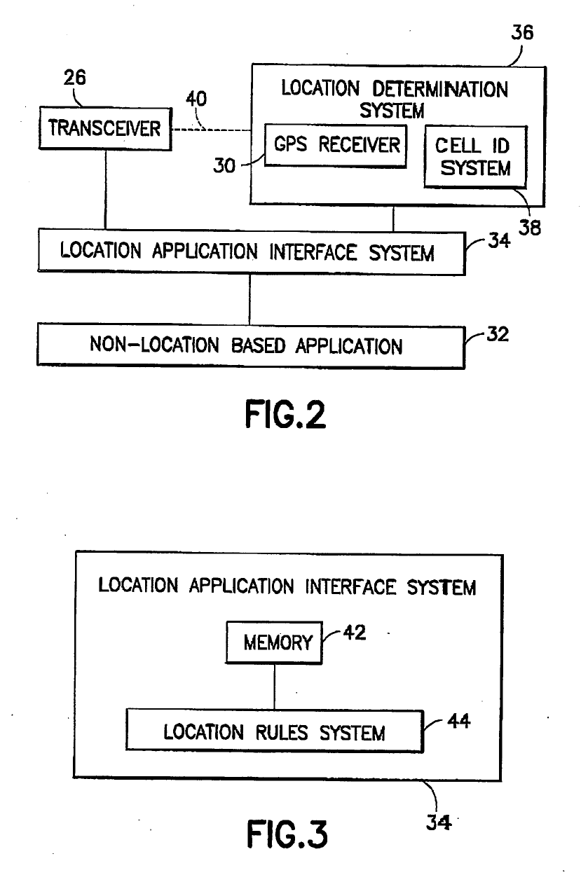

The mobile telephone 14 generally comprises a display 22, an input keypad 23, an antenna 24, a transceiver 26, and other electronic circuitry 28 including a processor. In alternate embodiments, the mobile telephone 14 could comprise additional or alternative components. In a preferred embodiment, the electronic circuitry 28 includes a global positioning system (GPS) receiver 30. The mobile telephone 14 can include one or more applications 32 (see FIG. 2) (software and/or firmware) such as, for example, a media player such as a music player, an incoming call signaler such as a vibrator and/or a ring/music generator, a video game display and sound generator, or any other type of mobile telephone application known in the art. These applications are non-location based applications. In other words, use of the applications by the telephone 14, or the user of the telephone 14, is not dependent upon the location of the telephone 14 relative to the other telephones 16, and perhaps not dependent upon the location of the telephone 14 relative to the base station 12.

Referring also to FIG. 2, the telephone 14 includes a location application interface system 34. The location application interface system to 34 is coupled to the transceiver 26 and at least one of the non-location based applications 32. The telephone 14 also comprises a location determination system 36. The location determination system 36 preferably comprises the GPS receiver 30 and can also comprise a cell identification system 38 for identifying a particular cell of the mobile device communication system 10.

The location determination system 36 is adapted to identify a location of the telephone 14. The location information determined by the location determination system 36 could be based upon a global system, such as is customary with a GPS system, or could be based upon a relative system, such as a distance between the telephone 14 and at least one of the other telephones 16 (which could be determined based upon a global system), or a relative system based upon boundary points or other boundary information entered into the telephone 14. The location determination function could be based on, for example, Observed Time Difference (OTB) data, Timing Advance (TA) data, Time Of Arrival (TOA) data, or GPS or differential GPS (DGPS) data.

The location determination system 36 is coupled to the location application interface system 34. In one type of alternate embodiment, the transceiver 26 could also be coupled to the location determination system 36 as indicated by connection 40. Referring also to FIG. 3, the location application interface system 34 generally comprises a memory 42 and a location rules system 44. The memory 42 is preferably adapted to store at least one location rule therein. The location rule could be a rule created by the user of the telephone 14 and entered into the telephone at the keypad 23 or other input device. The location rules system 44 is adapted to compare a location rule stored in the memory 44 to a location of the telephone 14, and/or a location of at least one of the other telephones 16, and/or a location of the telephone 14 relative to at least one of the other telephones 16. In a preferred embodiment, the location rules system 44 is adapted to compare a location rule stored in the memory 44 to a location of the telephone 14 relative to one or more of the locations of the other telephones 16.

The location application interface system 34 can have a user interface of its own that the end user uses to create and manage the Location rules in the location rules system 44. It is also possible that the non-location based application 32 has a method to create, activate, deactivate or otherwise manage and configure the location application interface system 34. It is also possible that there exists a separate, third-party application that exists to manage a set of location rules. It is possible that the location rules be grouped into separate groups, where each group would be associated to a specific management application.

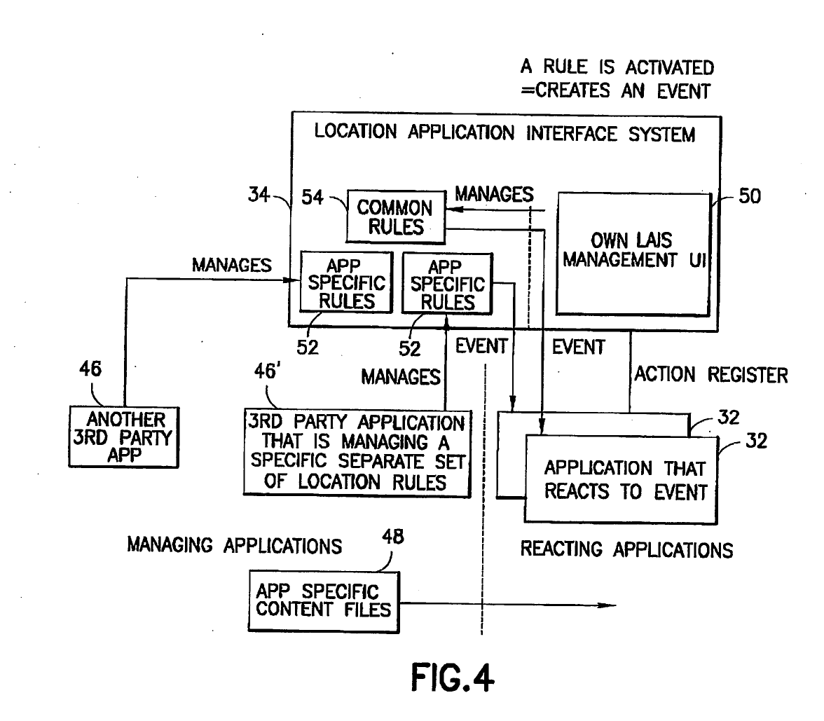

Referring now also to FIG. 4, a diagram of this type of embodiment is shown. A music player and music files exist in the terminal before any services that use the location application interface system 34 are first used. Therefore, with this in mind, it is possible to build a separate application 46, such as a third-party application, that utilizes the services of the location application interface system 34 to react to defined rules by either reacting with a reacting application 32, such as a music player, or reacting in the separate application 46 itself. A third-party application 46′ could be provided that is managing a specific separate set of location rules. Application specific rules 52 could be loaded into the interface system 34 as well as a common rules 54 from a User Interface 50.

There could be several different applications 46, 46′ that use the same location application interface system 34 and one or more of the same reacting application(s) 32. For example, one or more of the different applications 46 could be Java games that utilize a common Java framework in the terminal 14. The end user can purchase tens of different Java games and, when he gets bored, he deletes them. However, all of the games can utilize the Java framework in the terminal. Some applications 46 could bring their own content files 48. These could be played in the terminal resident reacting application(s) 32.

The reacting application(s) 32 can register with the location application interface system 34 so that the interface system 34 knows what kind of capabilities it has available when a rule is met. When a rule is created, the creating party can be offered a catalog of actions from all registered reacting applications 32. The creating party could be the end user via the user's own location application interface system management User Interface 50, or a third-party application. The rule contains the criteria and the reacting event.

In a preferred embodiment, the location application interface system 34 is always running. Management applications need not be running to check on the rules that they created. If an event occurs, one or more actions can be performed by the location application interface system 34 including, for example, opening a new application, opening the third-party management application that originated the role that was met, or playing a music or video file. This separation of the interface system 34, the managing applications, and the reacting applications 32, enables creation of purpose specific third-party applications for purpose build User Interface and automated event action creation and management.

A location rule stored in the memory 44 can comprise any one or more of a number of different parameters. The parameters can include for example:
an identification parameter of one or more of the other telephones 16 (in one or more groups);
a relative distance parameter;
a time and/or clock and/or day/date parameter;
a speed parameter;
a geographic boundary parameter;
a communications system cell identification parameter; or
any other suitable type of location parameter.

If a GPS enabled mobile phone, which also has a music player or other digital content viewing/consumption mechanism, is able to track the location of certain defined other GPS enabled mobile phones, it is an easy step to imagine applications to be developed which show the location of a group of people.

As a further step, since people store digital content in their phones, it is conceivable that the same location information could be used to guide the consumption or use of that content. For example, Phones A and B have shared their location information, so phone A knows the location of phone B and vice versa. Phone A is playing a music file according to a program which the user has specified (for example random play). The User of phone A has defined a location rule to be a trigger based upon User B's location. For example, the trigger can be set to react when User B comes within 3 kilometers of User A's registered home location. The music player in User A's phone can be programmed or set to react to this trigger/event by changing the music file to a predefined music file X. This way, when predefined music file X plays on phone A, User A knows that User B is about to arrive home without actively following the location of User B.

Also, the trigger could be defined to play “all is safe” type music when, for example, Users C and D (family kids) are with User B (mother) trigger location (such as 200 feet for example) when User group (B, C, D) are not at home. If, for example, User C becomes separated from User B and D by more than the trigger distance (such as 200 feet for example), the music could change to “something is wrong” type of music. This would signal the User A; enabling User A to contact user B immediately to see what is wrong and/or activate a map display and look on the screen of phone A to see where phone C of User C is located.

It is also conceivable that this functionality could be combined to the vibration alert feature in the phone (a non-location based application). Gentle pulsing of the phone would mean that all is safe, and alert vibration would mean that something is not within the set “safety parameters”.

Without a peer-location sensitive player, this kind of functionality could be built, but it would require constant monitoring on the monitoring user's part. The present invention allows making a location application interface (location API) into the mobile phone software and enabling applications to create groups of terminals whose location (GPS and cell location in covered areas) is shared within the group.

The users could be able to define rules for digital content consumption applications (such as music player) or other phone features (such as vibration alert) to react in a predetermined way to the information provided by the location API. Location could be GPS enabled in outdoors and/or, GPS and cell location assisted indoors. Shared locations could be communicated via short message system SMS or data connection to participating terminals. The system for sending location information comprises a short message service (SMS) or an enhanced message service (EMS) or a smart messaging system or a date connection system. There could be a “listener application” to listen to incoming SMSs to track location sharing specific SMSs from normal SMSs. When trigger rules require several terminals to be at or near a same location, and when terminals are capable to communicate over short range radio (i.e., Bluetooth) only one terminal needs to connect via SMS to the terminals that are not in perimeter. The telephone 14 could have a system for displaying a location of the second hand-held mobile communications device 16. The system for displaying can be adapted to display the location of the second hand-held mobile communications device 16 relative to the hand-held mobile communications device 14.

Location information could be offered via a “location sharing API”. “Sharing location application” could use existing user created groups to share the location info and define trigger events that would cause a predetermined action to take place. Sharing location application would be able to change music piece/start/end playing, and/or use vibration alert feature to communicate location status in silent mode. The present invention could enable a new breed of services and applications to mobile phones, and could best utilize the communication feature of a GPS enabled mobile phone. For example, school children at a shopping mall could have a location rule set to trigger a music player to automatically play a first song M when a first friend comes within a selected distance, such as 200 feet, and set to trigger the music player to automatically play a second song N when a second friend comes within a selected distance, such as 300 feet for example.

The present invention could also be used with a location based application. For example, when the telephone of user E comes within 1 mile of the telephone of user F, the telephone of user E could send a signal (such as an auditory signal or vibration signal) to User E, and automatically activate the location based application (such as a GPS mapping display for example). As another example, the telephone of User E could automatically send a signal to the telephone of User F.

As another example, the non-location based application could be a camera or video feature of one of the telephones 16 where the user is a child of a parent who is the user of telephone 14. If the telephone 16 is more than 100 feet from telephone 14 after 9:00 pm at night, the telephone 16 could automatically send pictures or video to telephone 14 or, send a message to telephone 14 and pictures or video to a storage location at base station 12 where the user of telephone 14 could subsequently view the pictures or video. This could help the parent know where the child is located.

As another example, a person waiting at a crowded restaurant could have their telephone automatically vibrate when his or her spouse enters or approaches the restaurant so the person can immediately start looking for the spouse without having to continuously look at a screen of the telephone 14 to see the spouse approaching.

As another example, school systems could send signals to registered telephones of school children that, while at the school, the telephones will not work or during certain times (such as during class times) they will not work, but could perhaps be used between class times. This invention could also be adapted such that picture or video taking capabilities are automatically disabled for registered locations such as bathrooms or changing rooms (such registered locations perhaps being automatically uploaded onto the telephone by a service provider, and added to a registered location list by owners of the locations). Thus, features of the present invention can be used to both enable applications as well as disable applications.

The sharing of one's location can be made into an API so that applications may react to the breaching of certain rules. Otherwise the user would need to follow where the other user is all the time. Thus, the present invention provides a passive location monitoring system which can be unseen or unnoticed by the user until a location rule is violated or its parameter (s) are met. This type of system is much better than a mere GPS type of display because the user is able to define rules and define an alert event that can take place if the rule is broken.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A hand-held mobile communications device comprising:
a location determination system for determining a location of the hand-held mobile communications device;
a system for sending location information of the hand-held mobile communications device to a second hand-held mobile communications device and for receiving location information of the second hand-held mobile communications device; and
a location application interface system comprising a memory adapted to store at least one location rule, wherein the location application interface system is adapted to automatically perform at least one predetermined task based, at least partially, upon a location of the hand-held mobile communications device and at least one location rule stored in the memory.

2. A hand-held mobile communications device as in claim 1 wherein the location determination system comprises a global positioning system (GPS) receiver.

3. A hand-held mobile communications device as in claim 2 wherein the location determination system comprises a mobile telephone cell identification location system.

4. A hand-held mobile communications device as in claim 1 wherein the location determination system is adapted to determine a relative location between the hand-held mobile communications device and the second hand-held mobile communications device.

5. A hand-held mobile communications device as in claim 1 wherein the hand-held mobile communications device comprises a mobile telephone.

6. A hand-held mobile communications device as in claim 1 wherein the system for sending location information comprises a short message service (SMS) or an enhanced message service (EMS) or a smart messaging system or a date connection system.

7. A hand-held mobile communications device as in claim 1 further comprising a system for displaying a location of the second hand-held mobile communications device.

8. A hand-held mobile communications device as in claim 7 wherein the system for displaying is adapted to display the location of the second hand-held mobile communications device relative to the hand-held mobile communications device.

9. A hand-held mobile communications device as in claim 1 wherein the at least one location rule comprises a distance rule regarding the hand-held mobile communications device relative to the second hand-held mobile communications device.

10. A hand-held mobile communications device as in claim 1 wherein the at least one predetermined task comprises sending a sensory signal to the user of the hand-held mobile communications device.

11. A hand-held mobile communications device as in claim 1 wherein the location application interface system is adapted to control a media player of the hand-held mobile communications device.

12. A hand-held mobile communications device as in claim 11 wherein the media player comprises a music player.

13. A hand-held mobile communications device comprising:
a location determination and receiving system for determining location of the hand-held mobile communications device and receiving location information with at least one second communications device; and
a location application interface adapted to perform at least one predetermined task eased upon the location information received from the second hand-held mobile communications device, wherein the predetermined task comprises at least partially controlling a non-location based application of the hand-held mobile communications device.

14. A hand-held mobile communications device as in claim 13 wherein the location determination and receiving system comprises a global positioning system (GPS) receiver.

15. A hand-held mobile communications device as in claim 14 wherein the location determination and receiving system comprises a mobile telephone cell identification location system.

16. A hand-held mobile communications device as in claim 13 wherein the location determination system is adapted to determine a relative location between the hand-held mobile communications device and the second hand-held mobile communications device.

17. A hand-held mobile communications device as in claim 13 wherein the hand-held mobile communications device comprises a mobile telephone.

18. A hand-held mobile communications device as in claim 13 wherein the location determination and receiving system comprises a short message service (SMS) or an enhanced message service (EMS) or a smart messaging system or a date connection system.

19. A hand-held mobile communications device as in claim 13 wherein the location determination and receiving system comprises a system for receiving location information of the second hand-held mobile communications device.

20. A hand-held mobile communications device as in claim 19 further comprising a system for displaying a location of the second hand-held mobile communications device.

21. A hand-held mobile communications device as in claim 20 wherein the system for displaying is adapted to display the location of the second hand-held mobile communications device relative to the hand-held mobile communications device.

22. A hand-held mobile communications device as in claim 13 wherein the location application interface comprises a memory adapted to store at least one location rule, and wherein the location application interface is adapted to perform at least one predetermined task based, at least partially, upon a location of the hand-held mobile communications device and at least one location rule stored in the memory.

23. A hand-held mobile communications device as in claim 22 wherein the at least one location rule comprises a distance rule regarding the hand-held mobile communications device relative to the second hand-held mobile communications device.

24. A hand-held mobile communications device as in claim 22 wherein the at least one predetermined task comprises sending a sensory signal to the user of the hand-held mobile communications device.

25. A hand-held mobile communications device as in claim 22 wherein the location application interface is adapted to control a media player of the hand-held mobile communications device.

26. A hand-held mobile communications device as in claim 25 wherein the media player is a music player.

27. A hand-held mobile communications device as in claim 13 wherein the location determination and receiving system is adapted to share location information between the device and the at least one second communications device.

28. A mobile telephone location signaling system comprising:
a first mobile telephone comprising a location determination and sharing system for determining a location of the first mobile telephone and transmitting information regarding the determined location; and
a second mobile telephone comprising a system for receiving the determined location information from the first mobile telephone, wherein the second mobile telephone comprises a location application interface system adapted to perform at least one predetermined task of a non-location based application based upon the location information shared by the first mobile telephone, and wherein the non-location based application comprises a music player of the second mobile telephone.

29. A mobile telephone location signaling system as in claim 28 wherein the location application interface is adapted control a vibrator of the second mobile telephone.

30. A mobile telephone location signaling system as in claim 28 wherein the second mobile telephone comprises a system for comparing the received location information to at least one location rule, and a system for sending a signal when the at least one location rule is violated.

31. A mobile telephone location signaling system as in claim 30 wherein the signal comprises a sensory signal to the user of the second mobile telephone.

32. A mobile telephone location signaling system as in claim 30 wherein the signal comprises a signal sent to the first mobile telephone by the second mobile telephone.

33. A hand-held mobile telephone comprising:
a location determination system for determining a location of the hand-held mobile communications device;
a location rules system for comparing location information of the hand-held mobile communications device, determined by the location determination system, to at least one user programmed location rule; and
a system for sending a sensory signal to a user of the hand-held mobile telephone when the location information violates the at least one user programmed location rule.

34. A method of communicating between hand-held mobile telephones comprising:
determining a location of a first one of the hand-held mobile telephones;
transmitting location information of the determined location from the first hand-held mobile telephone to a second one of the hand-held mobile telephones; and
comparing the location information to a location rule in the second hand-held mobile telephone.

35. A method as in claim 34 further comprising controlling a music player of the second hand-held mobile telephone based, at least partially, upon the step of comparing the location information to a location rule.

36. A method as in claim 34 further comprising activating a location application interface in at least one of the telephones based upon a predetermined location of the first hand-held mobile telephone relative to the second hand-held mobile telephone.

37. A hand-held mobile communications system comprising:
a first hand-held mobile communications device;
a second hand-held mobile communications device;
a third hand-held mobile communications device;
a system for sending a location information signal to the first hand-held mobile communications device based upon positions of the second and third hand-held mobile communications devices,
wherein the first hand-held mobile communications device comprises a location application interface adapted to perform at least one predetermined task based upon the location information signal received by the first hand-held mobile communications device.

38. A hand-held mobile communications system as in claim 37 wherein the predetermined task comprises at least partially controlling a non-location based application of the hand-held mobile communications device.

39. A hand-held mobile communications device comprising:
a location determination system for determining a location of the hand-held mobile communications device;
at least one location rule stored in a memory of the hand-held mobile communications device; and
a location application interface system adapted to automatically perform at least one predetermined task based, at least partially, upon the at least one location rule stored in the memory.

40. A hand-held mobile communications device comprising:
an alert receiving system adapted to receive an alert regarding location of a second hand-held mobile communications device;
at least one location rule stored in a memory of the hand-held mobile communications device; and
a location application interface system adapted to automatically perform at least one predetermined task based, at least partially, upon the at least one location rule stored in the memory and reception of the alert by the alert receiving system.

41. A hand-held mobile communications device comprising:
a system for receiving location information of a second hand-held mobile communications device;
at least one location rule stored in a memory of the hand-held mobile communications device; and
a location application interface system adapted to automatically perform at least one predetermined task based, at least partially, upon the at least one location rule stored in the memory and the location information of the second hand-held mobile communications device.

42. A hand-held mobile communications device comprising:
a location determination system for determining a location of the hand-held mobile communications device;
a location rules system for comparing location information of the hand-held mobile communications device, determined by the location determination system, to at least one user programmed location rule; and
a system for sending location information of the hand-held mobile communications device to a second hand-held mobile communications device based, at least partially, upon the at least one user programmed location rule.

43. A hand-held mobile communications device comprising:
a location determination system for determining a location of the hand-held mobile communications device;
a location rules system for comparing location information of the hand-held mobile communications device, determined by the location determination system, to at least one user programmed location rule; and
a system for transmitting a rule of the location rules system from the hand-held mobile telephone to a second hand-held mobile telephone.

44. A mobile location signaling system comprising:
a first mobile communications device comprising:
a location determination system for determining a location of the first mobile communications device;
at least one location rule stored in a memory of the first mobile communications device; and
a system for sending an alert when the location determined by the location determination system violates the at least one location rule;
a second mobile communications device comprising:
a system for receiving the alert from the first mobile communications device; and
a location application interface system adapted to automatically perform at least one predetermined task based, at least partially, upon the alert received by the system for receiving the alert from the first mobile communications device.

45. A mobile location signaling system comprising:
a first mobile communications device comprising:
a location determination system for determining a location of the first mobile communications device;
at least one location rule stored in a memory of the first mobile communications device; and
a system for sending location information of the first mobile communications device based, at least partially, upon the at least one location rule;
a second communications device comprising:
a system for receiving the location information of the first mobile communications device; and
a location application interface system adapted to automatically perform at least one predetermined task based, at Least partially, upon the location information received by the system for receiving the location information from the first mobile communications device.

46. A mobile location signaling system as in claim 45 wherein the second mobile communications device further comprises a location determination system for determining a location of the second mobile communications device, and wherein the location application interface system is adapted to automatically perform the at least one predetermined task based, at least partially, upon location information determined by the location determination system for determining the location of the second mobile communications device.

47. A mobile location signaling system as in claim 46 wherein the second mobile communications device further comprises at least one location rule stored in a memory of the second mobile communications device, and wherein the location application interface system is adapted to automatically perform the at least one predetermined task based, at least partially, upon the at least one location rule stored in a memory of the second mobile communications device.

48. A mobile location signaling system comprising:
a first mobile communications device comprising:
a location determination system for determining a location of the first mobile communications device;
at least one location rule stored in a memory of the first mobile communications device; and
a system for transmitting a location rule from the first mobile communications device
a second mobile communications device comprising:
a system for receiving the location rule from the first mobile communications device; and
a location application interface system adapted to automatically perform at least one predetermined task based, at least partially, upon the location rule received by the system for receiving the location rule from the first mobile communications device.

49. A hand-held mobile communications system comprising:
a first hand-held mobile communications device comprising:
a location determination system for determining a location of the first hand-held mobile communications device; and
at least one location rule stored in a memory of the first hand-held mobile communications device;
a second hand-held mobile communications device comprising a system for sending location information of the second mobile communications device; and
a third hand-held mobile communications device comprising a system for sending location information of the third mobile communications device,
wherein the first hand-held mobile communications device further comprises a system for receiving the location information of the second and third hand-held mobile communications devices, and a location application interface adapted to perform at least one predetermined task based, at least partially, upon the location information of the second and third hand-held mobile communications devices received by the first hand-held mobile communications device and the at least one location rule.
